(19) United States
(12) Patent Application Publication
(10) Pub. No.: US 2005/0031495 A1
(43) Pub. Date: Feb. 10, 2005

(54) Liquid chemical delivery system with recycling element and associated methods

(76) Inventors: Han-Mei Choi, Seoul (KR); Thomas Jongwon Kwon, Gyeonggi-do (KR); Jae-Soon Lim, Seoul (KR); Ki-Chul Kim, Gyeonggi-do (KR); Sung-Tae Kim, Seoul (KR); Young-Sun Kim, Gyeonggi-do (KR)

Correspondence Address: D. Randal Ayers;Myers Bigel Sibley & Sajovec, P.A., P.O. Box 37428, Raleigh, NC, 27627, US

(21) Appl. No.: 10/844,136

(22) Filed: May 12, 2004

(30) Foreign Application Priority Data
Aug. 5, 2003 (KR) 10-2003-0054092

(51) Int. Cl. B01L 3/02

(52) U.S. Cl. 422/100; 436/180

(57) ABSTRACT

Liquid chemical delivery systems are provided which include a liquid chemical storage canister, a pressurized gas source that feeds a pressurized gas into the storage canister, a vaporizer that may be used to vaporize the liquid chemical supplied from the storage canister, a delivery line that connects the storage canister to the vaporizer, a liquid mass flow controller that controls the flow rate of the liquid chemical through the delivery line, a reaction chamber that is connected to the vaporizer, and a liquid chemical recycling element that collects at least some of the chemical flowing through the system during periods when the liquid chemical delivery system is isolated from the reaction chamber.

### CLAIM OF PRIORITY

This application claims the priority under 35 U.S.C. §119 to Korean Patent Application No. 2003-54092, filed on Aug. 5, 2003 in the Korean Intellectual Property Office, the disclosure of which is incorporated herein in its entirety by reference.

### FIELD OF THE INVENTION

The present invention relates to chemical delivery systems and, more particularly, to a liquid chemical delivery system and associated methods.

### BACKGROUND OF THE INVENTION

Semiconductor devices are fabricated through various processes such as, for example, photolithography, etching and diffusion. A variety of different types of chemicals may be used in performing these and other semiconductor fabrication processes. In many of these processes, the chemicals used in the process are supplied in a liquid or gaseous from. Accordingly, both gas and liquid chemical delivery systems are known in the art. Liquid chemical delivery systems may be classified into at least two different types, namely (1) systems which supply a chemical vapor that has a vapor pressure that exceeds a predetermined pressure to a reaction chamber using a carrier gas and (2) systems which vaporize and supply a chemical having low vapor pressure to the reaction chamber.

Bubblers are one well known embodiment of the first type of liquid chemical delivery system identified above. Bubblers increase the vapor pressure in the canister that contains the liquid chemical by introducing a pressurized gas into the canister and the resulting chemical vapor is supplied to the reaction chamber using the pressurized gas as a carrier gas. In contrast, liquid chemical delivery systems of the second type identified above transport the liquid chemical to a vaporizer and the vaporized chemical is then introduced into the reaction chamber. Such liquid chemical delivery systems are disclosed in U.S. Pat. No. 6,204,204 entitled “METHOD AND APPARATUS FOR DEPOSITING TANTALUM-BASED THIN FILMS ORGANMETALLIC PRECURSOR” and U.S. Pat. No. 6,486,047 entitled “APPARAUS FOR FORMING STRONTIUM-TANTALUM OXIDE THIN FILM.”

FIG. 1 is a schematic diagram illustrating a conventional liquid chemical delivery system. As shown in FIG. 1, the liquid chemical delivery system includes a canister 6, a pressurized gas source 2, a vaporizer 12 and a reaction chamber 14. Liquid chemical is stored in the canister 6. The pressurized gas source 2 supplies a pressurized gas that applies pressure to the liquid chemical stored in the canister 6. The vaporizer 12 vaporizes the liquid chemical. The reaction chamber 14 receives the vaporized chemical. The pressurized gas is supplied to the canister 6 through a line 4 that includes a pressure valve V4. Liquid chemical is transferred from the canister 6 to the vaporizer 12 through a delivery line 8 that includes an isolation valve V6. The vaporized chemical is introduced into the reaction chamber 14 through a supply line 18 that includes a supply valve V8 or, alternatively, the vaporized chemical may be exhausted through a purge line 16 that includes a purge valve V10. A liquid mass flow controller (LMFC) 10 is installed in the delivery line 8 to control the flow rate of the liquid chemical.

When the pressure valve V4 is opened, the pressurized gas is introduced into the canister 6, thereby applying pressure to the liquid chemical stored therein. If the isolation valve V6 is opened, liquid chemical is supplied to the vaporizer 12. The flow rate of the liquid chemical is controlled by the LMFC 10. If the supply valve V8 is opened, chemical that was vaporized in the vaporizer 12 is supplied to the reaction chamber 14. This supply of chemical to the reaction chamber 14 may be interrupted by closing the supply valve V8 and opening the purge valve 10. The isolation valve V6 may also be closed to interrupt the supply of the liquid chemical from the canister 6.

In various processes that are used in the manufacture of semiconductor devices such as, for example, chemical vapor deposition (CVD) and atomic layer deposition (ALD), it may be necessary to periodically supply chemicals to the reaction chamber for relatively short intervals of time. When the prior art liquid chemical delivery system of FIG. 1 is used in such processes, the vaporizer 12 may be operated to continuously vaporize the chemical, and the supply valve V8 and the purge valve V10 are opened and closed such that the chemical is supplied to the reaction chamber during the appropriate intervals. However, this technique may result in significant waste of chemicals that are purged via the purge valve V10 during periods of time when the chemical is not introduced into the reaction chamber 14. This is particularly true in manufacturing processes, such as ALD, in which the chemical delivery flow time may be a small part of the overall processing time. The amount of chemical purged may be reduced and/or minimized by closing the isolation valve V6 simultaneously with the closing of the supply valve V8. When this technique is used, a stabilization step may be added to the process so that the amount of chemical flowing through the vaporizer 12 can be stabilized to the correct level before it is introduced into the reaction chamber 14. As such, use of this technique may increase the overall processing time.

### SUMMARY OF THE INVENTION

Pursuant to embodiments of the present invention, liquid chemical delivery systems are provided which include a liquid chemical storage canister, a pressurized gas source that feeds a pressurized gas into the storage canister, a vaporizer that may be used to vaporize the liquid chemical supplied from the storage canister, a delivery line that connects the storage canister to the vaporizer, a liquid mass flow controller that controls the flow rate of the liquid chemical through the delivery line, a reaction chamber that is connected to the vaporizer, and a liquid chemical recycling element that collects at least some of the chemical flowing through the system during periods when the liquid chemical delivery system is isolated from the reaction chamber. The liquid mass flow controller may be also be used to control both the amount of chemical provided to the reaction chamber as well as the amount of chemical diverted to the liquid chemical recycling element.

The liquid chemical recycling element may include a recycling line that feeds a liquid chemical recycling canister. An isolation valve may be provided in the recycling line, and/or the liquid chemical recycling canister may include an exhaust valve. In embodiments of the present invention, the liquid chemical recycling element may be downstream from the vaporizer. In such embodiments, the liquid chemical recycling element may include a condenser that liquefies the vaporized chemical. In other embodiments of the present invention, the liquid chemical recycling element may be upstream of the vaporizer.

In further embodiments of the present invention, methods are provided for operating a liquid chemical delivery system that includes a liquid chemical recycling element. Pursuant to these methods, a liquid chemical is flowed through the liquid chemical delivery system for a first period of time. The liquid chemical is vaporized and delivered to a reaction chamber during a first portion of the first period of time, while the liquid chemical is diverted to the liquid chemical recycling element during a second portion of the first period of time. The liquid chemical delivery system used in performing these methods may include a line mass flow controller that controls the flow of the liquid chemical through the liquid chemical delivery system. The line mass flow controller may operate continuously throughout the first period of time. The liquid chemical may also be flowed through the liquid chemical delivery system, vaporized, and delivered to the reaction chamber during a second period of time that follows the first period of time without introducing a stabilization step between the first and second periods of time.

### BRIEF DESCRIPTION OF THE DRAWINGS

FIG. 1 is a schematic diagram illustrating a conventional liquid chemical delivery system.

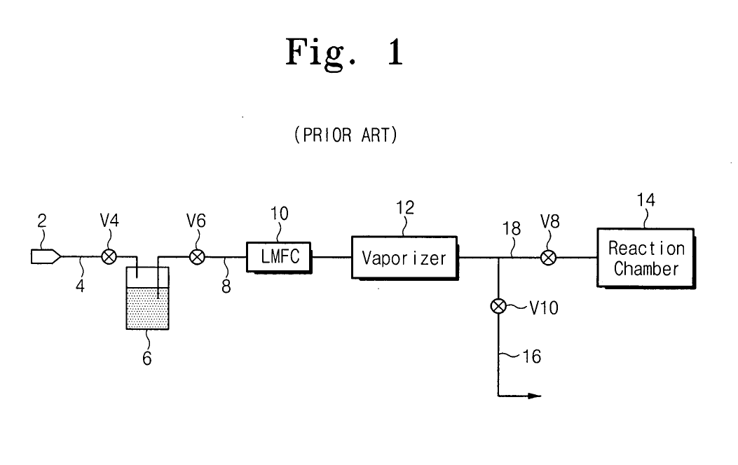

FIG. 2 is a schematic diagram illustrating a liquid chemical delivery system according to some embodiments of the present invention.

FIG. 3 is a flowchart diagram showing a method for abating efflux of liquid chemical using the liquid chemical delivery systems of FIG. 2.

FIG. 4 is a schematic diagram illustrating a liquid chemical delivery system according to further embodiments of the present invention.

FIG. 5 is a flowchart diagram showing a method for abating efflux of liquid chemical using the liquid chemical delivery systems of FIG. 4.

FIG. 6 is a schematic diagram showing a deposition apparatus that includes a liquid chemical delivery system as illustrated in FIG. 2.

FIG. 7 is a schematic diagram showing a deposition apparatus that includes a liquid chemical delivery system as illustrated in FIG. 4.

### DETAILED DESCRIPTION OF THE INVENTION

The present invention will now be described more fully with reference to the accompanying drawings, in which embodiments of the invention are shown. This invention, however, may be embodied in many different forms and should not be construed as limited to the embodiments set forth herein. Rather, these embodiments are provided so that this disclosure will be thorough and complete, and will fully convey the scope of the invention to those skilled in the art. It will also be understood that when two elements of the liquid chemical delivery systems described herein are referred to as being “connected” to one another, the two elements can be directly connected to one another, or intervening elements may also be present. In contrast, when two elements are referred to as being “directly connected” to one another, there are no intervening elements present. It will further be understood that the terms “upstream” and “downstream” are used to refer to the relative positions of elements of the liquid chemical delivery systems described herein with respect to the flow of the chemical through the system from the chemical supply source to the reaction chamber. Like reference numerals refer to like elements throughout.

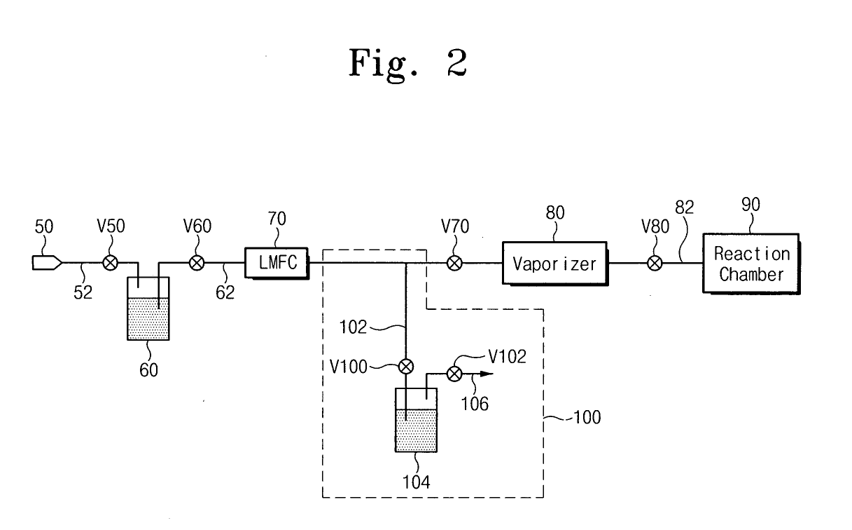

FIG. 2 is a schematic diagram of a liquid chemical delivery system according to some embodiments of the present invention. As shown in FIG. 2, the chemical delivery system includes a pressurized gas source 50, a storage canister 60, a vaporizer 80 and a reaction chamber 90. The pressurized gas source 50 supplies a pressurized gas that is used in the delivery of a liquid chemical to the reaction chamber 90. The storage canister 60 stores the liquid chemical that is to be delivered. The vaporizer 80 is used to evaporate the liquid chemical. The reaction chamber 90 may be used to perform one or more processes, at least one of which involves the introduction of an evaporated chemical into the reaction chamber 14. It will be appreciated that the storage canister 60 may be any container and/or storage device that is suitable for storing a liquid chemical.

As is also shown in FIG. 2, the pressurized gas source 50 is connected through a line 52 and a pressure valve V50 to the storage canister 60. Pressurized gas is supplied through the line 52 to the storage canister 60, thereby applying pressure to the liquid chemical in the canister 60. The outlet of the line 52 in the canister 60 may be located at a point higher than a maximum level of the liquid chemical in the storage canister 60. Liquid chemical is supplied to the vaporizer 80 through a delivery line 62 that connects the storage canister 60 to the vaporizer 80. A liquid mass flow controller (LMFC) 70 is installed in the delivery line 62 that controls the flow of the liquid chemical. The liquid mass flow controller 70 may be any device that acts to control the rate at which liquid chemical flows through the system. A first isolation valve V60 is provided between the canister 60 and the liquid mass flow controller 70, and a second isolation valve V70 is provided between the liquid mass flow controller 70 and the vaporizer 80. The vaporizer 80 is connected through a supply line 82 and a supply valve V80 to the reaction chamber 90.

As is further shown in FIG. 2, a liquid chemical recycling element 100 is installed in the delivery line 62 between the liquid mass flow controller 70 and the vaporizer 80. The liquid chemical recycling element 100 may be any element or elements that are used to capture at least some of the liquid chemicals supplied by the liquid chemical delivery system that are not introduced into the reaction chamber 90. In the embodiment of FIG. 2, the liquid chemical recycling element 100 includes a recycling canister 104 that may be used to store liquid chemicals and a recycling line 102 that connects the delivery line 62 to the recycling canister 104. An exhaust line 106 may further be provided that may be used to maintain the internal vapor pressure in the recycling canister 104 below a certain level. A valve V100 may be provided in the recycling line 102 and a valve V102 may be provided in the exhaust line 106. It will be appreciated that the exhaust system may be implemented as an exhaust line having an exhaust valve as depicted in FIG. 2 or that the exhaust valve may be built into the recycling canister 104. The exhaust valve V102, if provided, normally remains closed. However, the exhaust valve V102 may be opened when, for example, the pressure in the recycling canister 104 rises to a predetermined level so as to facilitate maintaining the pressure in the recycling canister below a predetermined level.

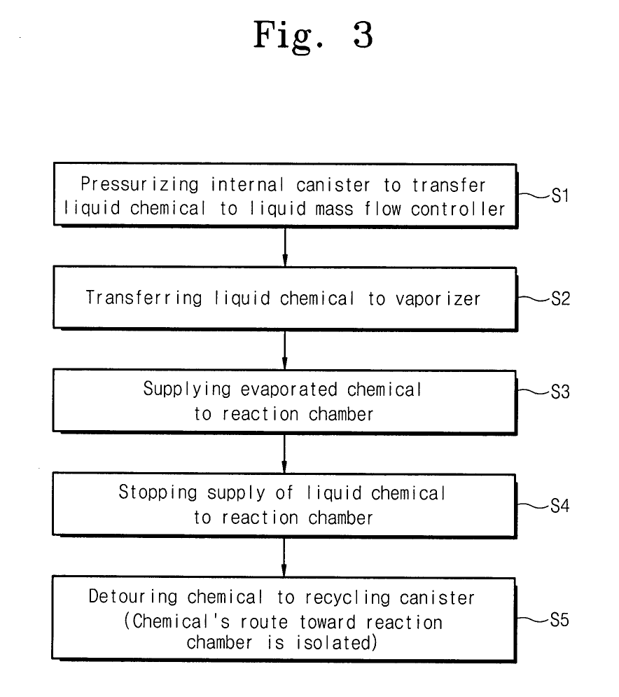

FIG. 3 is a flowchart showing a method for reducing and/or minimizing the efflux of liquid chemical in a liquid chemical delivery system in accordance with some embodiments of the present invention. As shown in step S1 in FIG. 3, the canister 60 is pressurized to transfer liquid chemical from the canister 60 to the liquid mass flow controller 70. This may be accomplished, for example, by supplying a pressurized gas to the storage canister 60 by opening the pressure valve V50, thereby pressurizing the liquid chemical stored therein. The first isolation valve V60 is opened, and the pressurized liquid chemical is transferred through the delivery line 62 to the liquid mass flow controller 70. The liquid mass flow controller 70 controls the flow rate of the liquid chemical.

As shown at step S2 in FIG. 3, the liquid chemical is transferred to the vaporizer 80. This may be accomplished, for example, by transmitting a supply start pulse to the chemical delivery system that causes the second isolation valve V70 to be opened, allowing the liquid chemical to flow through the delivery line 62 to the vaporizer 80.

As indicated at step S3 in FIG. 3, the vaporizer 80 evaporates the liquid chemical. The evaporated chemical is then supplied through the delivery line 82 and the supply valve V80 to the reaction chamber 90.

As shown at step S4 in FIG. 3, at some point the flow of liquid chemical to the reaction chamber 90 is halted. This may be accomplished, for example, by transmitting a supply stop pulse to the chemical delivery system that closes the second isolation valve V70, thereby stopping the flow of liquid chemical. When this occurs, the liquid mass flow controller 70 may continue to operate, thereby maintaining a constant flow of the liquid chemical.

As shown at step S5 in FIG. 3, the chemical flowing from the liquid mass controller is diverted to the recycling canister 104. This may be accomplished, for example, by opening recycling valve V100 so that liquid chemical passing through the liquid mass flow controller 70 is diverted toward the recycling canister 104 to be stored. As noted above, the liquid mass flow controller 70 continues to operate while the liquid chemical is detoured toward the recycling canister 104. As a result, the liquid chemical may continue to flow at a constant rate or may be controlled to flow at a rate suitable for the next delivery pulse. As a result, the chemical delivery system can reduce and/or minimize efflux of the chemical during periods when the chemical is not being delivered to the reaction chamber 90. Additionally, during the next period where the liquid chemical is supplied to the reaction chamber a stabilization step may not be required.

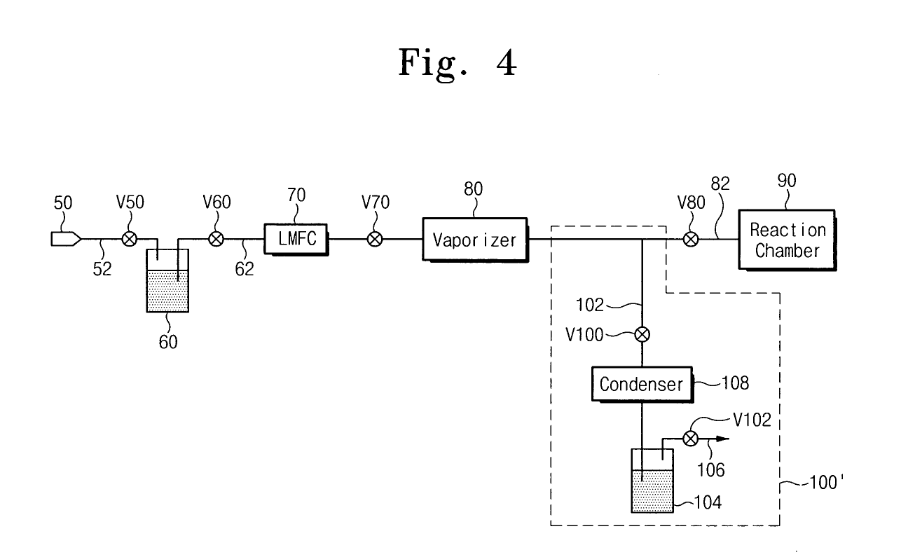

FIG. 4 is a schematic diagram of a liquid chemical delivery system according to further embodiments of the present invention. As shown in FIG. 4, the liquid chemical delivery system includes a pressurized gas source 50, a storage canister 60 that contains a liquid chemical, a vaporizer 80 that may be used to evaporate the liquid chemical and a reaction chamber 90 that may be used to perform a process. The pressurized gas source 50 is connected to the storage canister 60 through a line 52 that includes a pressure valve V50. Pressurized gas is supplied through the line 52 to the storage canister 60, thereby applying a pressure to the liquid chemical in the canister 60. The liquid chemical is supplied to the vaporizer 80 through delivery line 62 that connects the storage canister 60 to the vaporizer 80. A liquid mass flow controller 70 that controls the flow of the liquid chemical is provided in the delivery line 62. A first isolation valve V60 is provided between the canister 60 and the liquid mass flow controller 70 and a second isolation valve V70 is provided between the liquid mass flow controller 70 and the vaporizer 80. The vaporizer 80 is connected through a supply line 82 with a supply valve V80 to the reaction chamber 90.

As shown in FIG. 4, a liquid chemical recycling element 100′ is connected to the supply line 82. The liquid chemical recycling element 100′ includes a recycling canister 104, a recycling line 102 and a condenser 108. The recycling canister 104 may store liquid chemical. The recycling line 102 is connected between the supply line 82 and the recycling canister 104. The condenser is installed in the recycling line 102. A recycling valve V100 is provided in the recycling line 102. To maintain pressure in the recycling canister 104 below a constant level, the recycling canister 104 may include an exhaust line 106 and an exhaust valve V102.

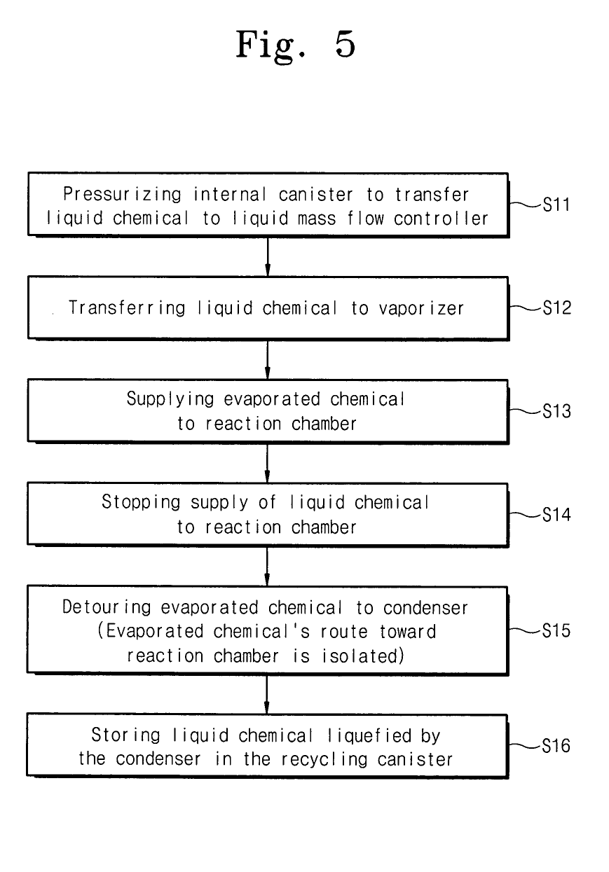

FIG. 5 is a flowchart illustrating a method for abating the efflux of liquid chemical using a liquid chemical delivery system in accordance with further embodiments of the present invention. As shown at step S11 in FIG. 5, the canister 60 containing the liquid chemical is pressurized to transfer the liquid chemical to the liquid mass flow controller 70. This may be accomplished, for example, by supplying pressurized gas to the canister 60 by opening the valve V50, thereby applying pressure to the liquid chemical in the canister 60. The first isolation valve V60 is opened, and the pressurized liquid chemical is transferred through the delivery line 62 to the liquid mass flow controller 70. The liquid mass flow controller 70 acts to control the flow rate of the liquid chemical which is transferred through the delivery line 62.

As shown at step S12 in FIG. 5, the liquid chemical may then be transferred from the liquid mass flow controller 70 to the vaporizer 80. This may be accomplished, for example, by opening the second isolation valve V70. The liquid chemical is then vaporized in the vaporizer 80.

As shown at step S13 in FIG. 5, the liquid chemical is next transferred from the vaporizer 80 to the reaction chamber 90. This may be accomplished, for example, by opening the supply valve V80 and supplying the vaporized chemical to the reaction chamber 90 through the supply line 82.

As shown at steps S14 and S15 in FIG. 5, at some point during the processing the flow of chemical to the reaction chamber 90 is halted. This may occur, for example, when a supply stop pulse is transmitted to the chemical delivery system. In response to such a supply stop pulse, the supply valve V80 is closed, and the recycling valve V100 is opened. As a result, the evaporated chemical is detoured to the recycling line 102.

As shown at step S16 in FIG. 5, the condenser 108 liquefies the evaporated chemical. This liquid chemical is stored in the recycling canister 104. The liquid mass flow controller 70 and the vaporizer 80 are operated continuously during the time period when the evaporated chemical is detoured through the recycling line 102, thereby controlling the flow of the chemical such that the flow will be suitable for the next supply pulse. By recycling chemical that is not fed into the reaction chamber 90, the chemical delivery system can reduce and/or minimize the efflux of chemical that can occur, for example, during extended supply stop pulse periods. Moreover, the chemical delivery system can typically resume supplying evaporated chemicals to the reaction chamber 90 without a stabilization step. As discussed with respect to the previous embodiments of the present invention, the exhaust valve V102 may be opened when the pressure in the recycling canister approaches a predetermined level.

As noted above, the liquid chemical delivery systems according to embodiments of the present invention can be used with chemical vapor deposition (CVD), atomic layer deposition (ALD) and various other processes.

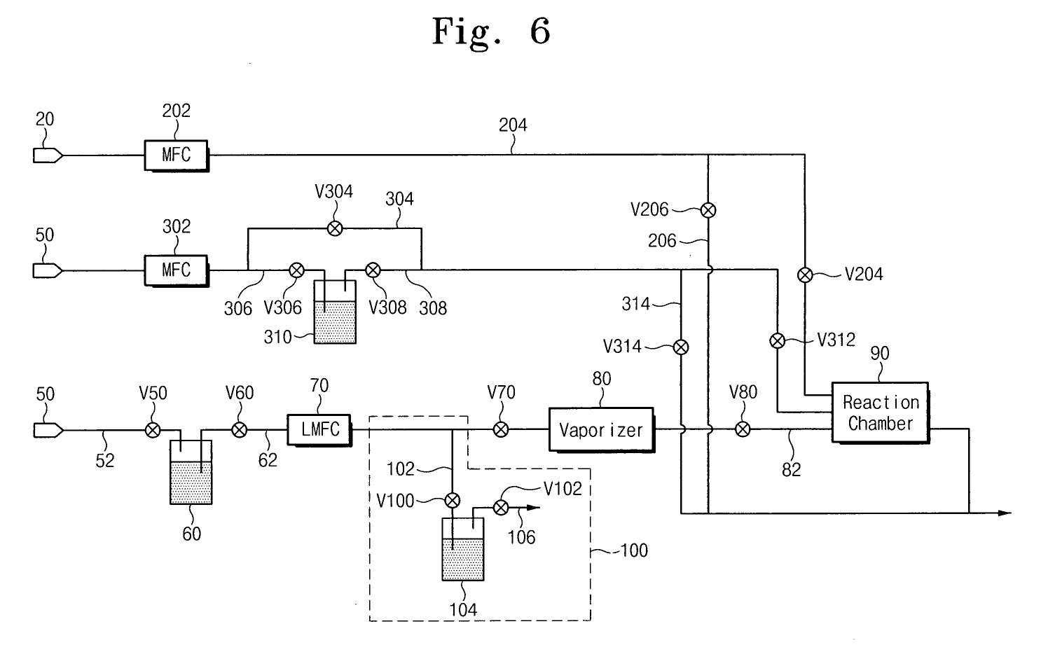

FIG. 6 is a schematic diagram illustrating a deposition device that includes a liquid chemical delivery system according to the certain embodiments of the present invention. The deposition device of FIG. 6 may be used to supply a gas chemical, a liquid chemical having a high vapor pressure and/or a liquid chemical having a low vapor pressure. In applications where the device is used to supply a liquid chemical having a high vapor pressure, the vapor pressure of the liquid chemical can be raised, for example, using a bubbler, and the liquid chemical may be transferred to the reaction chamber by a carrier gas.

As shown in FIG. 6, the chemical delivery system of the deposition device includes a first chemical delivery system that uses a gas chemical, a second chemical delivery system that includes a bubbler mode and a third chemical delivery system that includes a forced vaporization mode. This device includes a gas source 50 that provides a pressurized gas and a gas chemical source 20 for providing gas chemical.

As shown in FIG. 6, the gas chemical source 20 is connected to a first supply line 204 that provides the gas chemical to the reaction chamber 90. A first supply valve V204 and a mass flow controller 202 are installed in the first supply line 204. A first purge valve V206 is installed in a first purge line 206 that branches off from the first supply line 204. Gas chemical that is not supplied to the reaction chamber is exhausted to an exhaust pump (not shown) through the first purge line 206.

A first pressurized line 306 and a second pressurized line 52 are connected to the pressurized gas source 50, which provides the pressurized gas that is used by the second and third chemical delivery systems. The first pressurized line 306 feeds a first storage canister 310 of the second chemical delivery system. The second pressurized line 52 feeds a second storage canister 60 of the third chemical delivery system. A mass flow controller (MFC) 302 for controlling the flow of the pressurized gas and a first pressure valve V306 are also included in the first pressurized line 306. Vaporized liquid chemical from the first storage canister 310 is supplied through a second supply line 308 to the reaction chamber 90. A first isolation valve V308 and a second isolation valve V312 are installed in the second supply line 308. A by-pass line 304 that includes a by-pass valve V304 branches off from the first pressurized line 306 to connect to the second supply line 308 between the first isolation valve V308 and the second isolation valve V312. A second purge line 314 that includes a second purge valve V314 also branches off from the second supply line 308.

The third chemical delivery system is the liquid chemical delivery system according to some embodiments of the present invention that is described above with respect to FIG. 2. As shown in FIG. 6, the second pressure line 52 connects the pressurized gas source 50 to the second storage canister 60. A second pressure valve V50 is installed in the second pressure line 52. The second storage canister 60 is connected through a delivery line 62 to the vaporizer 80. A liquid mass flow controller (LMFC) 70 and second and third isolation valves V60, V70 are installed in the delivery line 62. The vaporizer 80 is connected through a third supply line 82 (which includes a third supply valve V80) to the reaction chamber 90. A liquid chemical recycling element 100 is connected to the delivery line 62 between the LMFC 70 and the third isolation valve V70. The liquid chemical recycling element 100 includes a recycling line 102 that branches off from the delivery line 62, a recycling canister 104 that is connected to the recycling line 102, and an exhaust line 106 that is connected to the recycling canister 104. A recycling valve V100 and an exhaust valve V102 are installed in the recycling line 102 and the exhaust line 106, respectively.

The third chemical delivery system may reduce and/or minimize the loss of liquid chemical by diverting chemicals supplied by the third chemical delivery system to the recycling device 100 during the step of purging the reaction chamber 90 and during periods where the first and/or second chemical delivery systems are supplying chemicals to the reaction chamber 90. A chemical recycling device 100 may also be installed in the second chemical delivery system and/or the second and third chemical delivery systems can share a common chemical recycling device 100. It also is possible to reduce and/or minimize consumption of the liquid chemical provided by the second chemical delivery system by detouring pressurized gas to the by-pass line 304 during periods when the second chemical delivery system is not supplying chemicals to the reaction chamber 90.

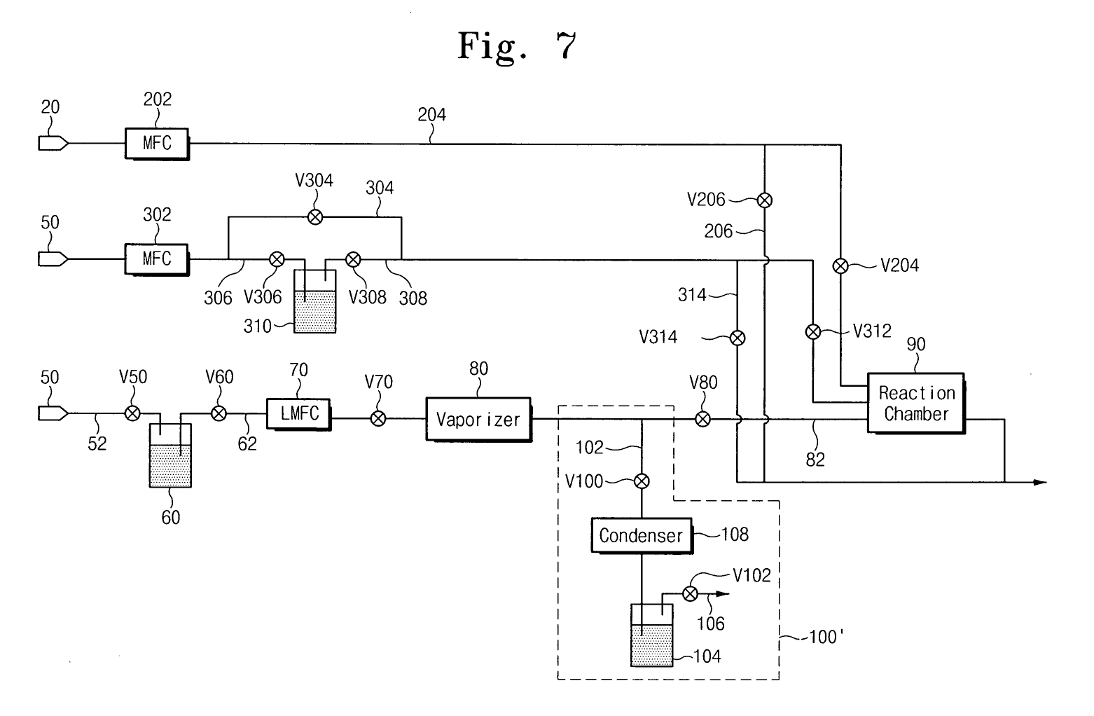

FIG. 7 is a schematic diagram illustrating a deposition device that includes a liquid chemical delivery system according to further embodiments of the present invention. As shown in FIG. 7, the deposition device includes a first chemical delivery system that supplies a gas chemical, a second chemical delivery system that uses a bubbler and a third chemical delivery system of the forced vaporization type. The device includes a pressurized gas source 50 and a gas chemical source 20.

As shown in FIG. 7, the gas chemical source 20 is connected to a first supply line 204 that provides the gas chemical to the reaction chamber 90. A first supply valve V204 and a mass flow controller 202 are installed in the first supply line 204. A first purge valve V206 is installed in a first purge line 206 that branches off from the first supply line 204. Gas chemical that is not supplied to the reaction chamber is exhausted to an exhaust pump (not shown) through the first purge line 206.

A first pressurized line 306 and a second pressurized line 52 are connected to the pressurized gas source 50. As shown in FIG. 7, the pressurized gas source 50 supplies pressurized gas to both the second and third chemical delivery systems. The first pressurized line 306 feeds a first storage canister 310 of the second chemical delivery system. The second pressurized line 52 feeds a second storage canister 60 of the third chemical delivery system. A mass flow controller (MFC) 302 for controlling the flow of the pressurized gas and a first pressure valve V306 are installed in the first pressure line 306. Vaporized chemical from the first storage canister 310 is supplied through a second supply line 308 to the reaction chamber 90. A first isolation valve V308 and a second isolation valve V312 are installed in the second supply line 308. A by-pass line 304 that includes a by-pass valve V304 branches off from the first pressure line 306 and connects to the second supply line 308 between the first isolation valve V308 and the second isolation valve V312. The second purge line 314 branches off from the second supply line 308 and includes a second purge valve V314.

The third chemical delivery system included in the device of FIG. 7 is the liquid chemical delivery system according to further embodiments of the present invention discussed above with respect to FIG. 4. A second pressurized line 52 connects the pressurized gas source 50 to a second storage canister 60, and a second pressure valve V50 is installed in the second pressurized line 52. The second storage canister 60 is connected through a delivery line 62 to the vaporizer 80. A liquid mass flow controller (LMFC) 70 and second and third isolation valves V60, V70 are installed in the delivery line 62. The vaporizer 80 is connected through a third supply line 82 and a third supply valve V80 to the reaction chamber 90. A liquid chemical recycling element 100′ is connected to the third delivery line 82 between the vaporizer 80 and the third supply valve V80. The liquid chemical recycling element 100′ includes a recycling line 102 that branches off from the third delivery line 82, a condenser 108 that is installed in the recycling line 102, a recycling canister 104 that is connected to the recycling line 102 and an exhaust line 106 that is connected to the recycling canister 104. A recycling valve V100 and an exhaust valve V102 are installed in the recycling line 102 and the exhaust line 106, respectively.

The third chemical delivery system may reduce and/or minimize the loss of liquid chemical supplied by detouring chemicals supplied by the third chemical delivery system to the recycling device 100 during the step of purging the reaction chamber 90 and during periods where the first and/or second chemical delivery systems are supplying chemical to the reaction chamber 90. In particular, when the third supply valve V80 is closed, the recycling valve V100 is opened so that the evaporated chemical is provided through the recycling line 102 to the condenser 108. The second liquid chemical liquefied by the condenser 108 is stored in the recycling canister 104.

As previously mentioned, according to embodiments of the present invention, a liquid chemical recycling element may be included in liquid chemical delivery systems that are used in semiconductor fabricating facilities.

Conventional mass flow controllers typically use a stabilization step to ensure a stable flow of liquid chemical after a period where the chemical was not flowing. According to embodiments of the present invention, such a stabilization step may be omitted since the liquid mass flow controller may be operated continuously with unused chemical diverted to the recycling device.

While the present invention has been described with reference to exemplary embodiments thereof, it will be understood by those of ordinary skill in the art that various changes in form and details may be made therein without departing from the spirit and scope of the present invention as defined by the following claims.

1. A liquid chemical delivery system comprising:
a liquid chemical storage canister that contains a liquid chemical;
a pressurized gas source that feeds a pressurized gas into the liquid chemical storage canister;
a vaporizer that vaporizes the liquid chemical for delivery to a reaction chamber;
a delivery line connecting the liquid chemical storage canister to the vaporizer;
a liquid mass flow controller that controls the flow rate of the liquid chemical through the delivery line; and
a liquid chemical recycling element downstream of the liquid mass flow controller that collects at least some of the chemical flowing through the system during periods when the liquid chemical delivery system is isolated from the reaction chamber.

2. The liquid chemical delivery system of claim 1, wherein the liquid mass flow controller controls the amount of chemical diverted to the liquid chemical recycling element.

3. The liquid chemical delivery system of claim 1, wherein the liquid chemical recycling element comprises a recycling line that feeds a liquid chemical recycling canister.

4. The liquid chemical delivery system of claim 3, wherein the recycling line includes an isolation valve.

5. The liquid chemical delivery system of claim 3, wherein the liquid chemical recycling canister includes an exhaust valve.

6. The liquid chemical delivery system of claim 2, further comprising a vaporizer that is connected to the reaction chamber.

7. The liquid chemical delivery system of claim 6, wherein the liquid chemical recycling element is downstream from the vaporizer and wherein the liquid chemical recycling element further comprises a condenser that liquefies the vaporized chemical.

8. The liquid chemical delivery system of claim 6, wherein the liquid chemical recycling element is upstream of the vaporizer.

9. A method for operating a liquid chemical delivery system that includes a liquid chemical recycling element, the method comprising:
flowing a liquid chemical through the liquid chemical delivery system for a first period of time;
vaporizing the liquid chemical and delivering the vaporized liquid chemical to a reaction chamber during a first portion of the first period of time; and
diverting the liquid chemical to the liquid chemical recycling element during a second portion of the first period of time.

10. The method of claim 9, wherein the liquid chemical delivery system includes a line mass flow controller that controls the flow of the liquid chemical through the liquid chemical delivery system.

11. The method of claim 10, wherein the line mass flow controller operates continuously throughout the first and second portions of the first period of time.

12. The method of claim 11, further comprising flowing the liquid chemical through the liquid chemical delivery system, vaporizing the liquid chemical and delivering the vaporized liquid chemical to the reaction chamber immediately after the second portion of the first period of time.

13. The method of claim 9, wherein the liquid chemical recycling element comprises a recycling line that feeds a liquid chemical recycling canister.

14. The method of claim 13, wherein diverting the liquid chemical to the liquid chemical recycling element during a second portion of the first period of time comprises diverting the liquid chemical to the recycling element before the liquid chemical is vaporized during the second portion of the first period of time.

15. The method of claim 13, wherein diverting the liquid chemical to the liquid chemical recycling element during a second portion of the first period of time comprises diverting the vaporized liquid chemical to the recycling element during the second portion of the first period of time.

16. The method of claim 15, wherein the liquid chemical recycling element further comprises a condenser and wherein the method further comprises condensing the vaporized liquid chemical and storing the condensed liquid chemical in the liquid chemical recycling canister.

17. The method of claim 13, wherein the liquid chemical recycling canister includes an exhaust valve, and wherein the method further comprises opening the exhaust valve to reduce the pressure in the liquid chemical recycling canister.

18. The method of claim 9, wherein flowing a liquid chemical through the liquid chemical delivery system for a first period of time comprises:
storing the liquid chemical in a storage canister; and
pressurizing the contents of the storage canister to transfer the liquid chemical to a liquid mass flow controller.

19. The method of claim 9, further comprising stabilizing the flow of liquid chemical to a level required during a subsequent processing step during the second portion of the first period of time.

20. A chemical delivery system, comprising:
a gas chemical delivery system configured to supply a gaseous chemical from a gaseous chemical source to a reaction chamber;
a first liquid chemical delivery system comprising a pressurized gas source that feeds a bubbler through a mass flow controller for supplying a first liquid chemical to the reaction chamber; and
a second liquid chemical delivery system configured to supply a second liquid chemical to the reaction chamber, the second liquid chemical delivery system comprising:
a liquid chemical storage canister that is fed by the pressurized gas source;
a vaporizer that supplies the vaporized liquid chemical to the reaction chamber;
a delivery line connecting the liquid chemical storage canister to the vaporizer;
a liquid mass flow controller that controls the flow rate of the liquid chemical through the delivery line; and
a liquid chemical recycling element that collects at least some of the liquid chemical flowing through the system during periods when the liquid chemical delivery system is isolated from the reaction chamber.

21. The chemical delivery system of claim 20, wherein the liquid chemical recycling element comprises a recycling line that feeds a liquid chemical recycling canister and an isolation valve.

22. The chemical delivery system of claim 21, wherein the liquid chemical recycling canister includes an exhaust valve.

23. The chemical delivery system of claim 21, wherein the liquid chemical recycling element is downstream from the vaporizer and wherein the liquid chemical recycling element further comprises a condenser that liquefies the vaporized chemical.

24. The chemical delivery system of claim 21, wherein the liquid chemical recycling element is upstream of the vaporizer.

25. The chemical delivery system of claim 20, wherein the liquid mass flow controller controls the amount of chemical diverted to the liquid chemical recycling element.

26. A liquid chemical delivery system, comprising:
chemical supply means for supplying a vaporized liquid chemical to a reaction chamber; and
a liquid chemical recycling element coupled to the chemical supply means that is configured to recycle at least some of the liquid chemical that flows through the chemical supply means during periods when the liquid chemical delivery system is isolated from the reaction chamber.

27. A method for reducing efflux of liquid chemical from a liquid chemical delivery system that periodically provides an evaporated liquid chemical to a reaction chamber at a controlled flow rate, the method comprising:
diverting at least some of the liquid chemical flowing through the liquid chemical delivery system to a storage container during periods when the reaction chamber is isolated from the liquid chemical delivery system.

28. The method of claim 27, wherein the chemical delivery system includes a liquid mass flow controller, and wherein the method further comprises running the liquid mass flow controller continuously during at least some of the periods when the reaction chamber is isolated from the liquid chemical delivery system.
